(19) United States
(12) Patent Application Publication
(10) Pub. No.: US 2025/0070521 A1
(43) Pub. Date: Feb. 27, 2025

(54) EDGE-MOUNT CONNECTOR

(71) Applicant: Samtec, Inc., New Albany, IN (US)

(72) Inventor: Christopher W. SHELLY, New Albany, IN (US)

(21) Appl. No.: 18/724,845

(22) PCT Filed: Dec. 28, 2022
(86) PCT No.: PCT/US2022/054170

§ 371 Date: Jun. 27, 2024

Related U.S. Application Data
(60) Provisional application No. 63/294,323, filed on Dec. 28, 2021.

(51) Int. Cl. H01R 24/50; H01R 103/00

(52) U.S. Cl. CPC H01R 24/50; H01R 2103/00

(57) ABSTRACT

An edge-mount connector that self-adjusts against an edge thickness of a substrate, such as a printed circuit board. Rotation of fasteners, along with direct or indirect engagement between the fasteners and corresponding surfaces on the edge-mount connector or a clamp of the edge-mount connector can walk the edge-mount connector towards and against the edge thickness of the substrate.

### CROSS REFERENCE TO RELATED APPLICATIONS

This application claims the benefit of U.S. Provisional Application No. 63/294,323, filed Dec. 28, 2021. The entire contents of this application is hereby incorporated by reference.

### BACKGROUND OF THE INVENTION

### 1. Field of the Invention

The present invention relates to edge-mount or mounted connectors, including edge-mount or mounted RF connectors.

### 2. Description of the Related Art

FIGS. 11-13 show an example of a known edge-mount connector 100. Specifically, FIGS. 11-13 show ELF67-001, a 1.85-mm, RF, edge-launch connector commercially available from SIGNAL MICROWAVE.

As shown in FIGS. 11-13, the known edge-mount connector 100 includes a port 112 with external threads 116, and the port 112 can be defined by a body 118. The body 118 can be mounted to a substrate, such as a printed circuit board, by tightening a first fastener 134 and a second fastener 136 while the substrate is provided between a first clamp 122 and a second clamp 126 of the body 118. As shown in FIGS. 11 and 13, the known edge-mount connector 100 includes a first lock washer 135 provided between a head of first fastener 134 and the second clamp 126, and the known edge-mount connector 100 also includes a second lock washer 137 provided between a head of second fastener 136 and the second clamp 126.

However, the known edge-mount connector 100 does not include any structural features that enable the known edge-mount connector 100 to pull, push, walk, or advance toward an edge of the substrate. That is, the known edge-mount connector 100 is unable to self-adjust with respect to the edge of the substrate.

### SUMMARY OF THE INVENTION

One aspect of this disclosure can include an edge-mount connector, such as an RF edge-mount connector, that pulls, pushes, walks, or advances toward an edge of a substrate, such as a thickness edge of the substrate. Self-adjustment of the edge-mount connector with respect to an edge of a substrate can be provided by a direct or indirect interaction between a head of a rotatable fastener and a protrusion/projection, a hole, or both a protrusion/projection and a hole. The protrusion/projection, the hole, or both the protrusion/projection and the hole can be defined by a second clamp surface of the edge-mount connector.

A method can include a step of providing an edge-mount connector. The edge-mount connector can include a body. Another step can include positioning the edge-mount connector adjacent to a substrate edge of a substrate. Another step can include moving a first end of the body of the edge-mount connector a greater distance toward the substrate edge of the substrate than an opposed second end of the body of the edge-mount connector. Another step can include moving the second end of the body of the edge-mount connector a greater distance toward the substrate edge of the substrate than the opposed first end of the body of the edge-mount connector. Another step can include moving the second end of the body of the edge-mount connector a greater distance toward the substrate edge of the substrate than the opposed first end of the body of the edge-mount connector after the step of moving a first end of the body of the edge-mount connector a greater distance toward the substrate edge of the substrate than an opposed second end of the body of the edge-mount connector.

According to an embodiment of the present invention, an edge-mount connector is configured to walk or advance toward an edge of a mating substrate, as the edge-mount connector is mated with the mating substrate, through a direct or indirect interaction between a head of a rotatable fastener and a corresponding protrusion/projection or indentation defined by a portion of the edge-mount connector.

The edge-mount connector can be an RF edge-mount connector. The interaction can be a direct or indirect physical interaction or a direct or indirect frictional interaction.

The edge-mount connector can define a port. The port can define a cavity. The port can define external threads. The port can be defined by a body. The body can define one or more protrusions. The one or more protrusions can individually or collectively engage with, can be monolithically formed with, or can be positioned adjacent to a first clamp.

The first clamp can define one or more first clamp fastener holes. A first clamp fastener hole of the first clamp can define an inner threaded diameter that is approximately equal to an outer threaded diameter of a corresponding first fastener, second fastener, or both first and second fasteners. At least one of a first fastener and a second fastener can be configured to be each be threaded into a corresponding first clamp fastener hole and tightened.

The edge-mount connector can further include a second clamp. The second clamp can define one or more second clamp fastener holes. The one or more second clamp fastener holes can be oversized. The one or more second clamp fastener holes can be configured to allow the second clamp to move with respect to a body. The second clamp can define a first surface and an opposed second surface. The first surface of the second clamp can define either a first projection or both first and second projections. The first projection can be monolithic with the second clamp. The second projection can be monolithic with the second clamp.

The first surface of the second clamp can define either a first indentation or both first and second indentations. The first indentation can be monolithic with the second clamp. The second indentation can be monolithic with the second clamp.

The edge mount connector can be made from an electrically conductive material.

The edge-mount connector can further include a first fastener and a second fastener that are each configured to be individually rotated in a rotation direction. The first fastener and the second fastener can be configured to alternatingly rotate or tighten such that the first fastener can be rotated a quarter turn or less than a full turn, then the second fastener can be rotated a quarter turn or less than a full turn, and then the first fastener can be rotated another quarter turn or less than a full turn. As the first fastener is turned in an R direction or is tightened, a first head surface of a first fastener head can physically or frictionally engage the first projection.

At least one of the first projection and the second projection can have a thickness of approximately 0.1 mm to approximately 0.2 mm. The first projection can be configured to be positioned on one side or only on one side of a respective second clamp fastener hole of the one or more second clamp fastener holes. The respective second clamp fastener hole can define a first circumference, and the first projection occupies or partially surrounds at least half, only half, or only less than half of the first circumference.

The first projection can define a C-shape. The second projection can define a C-shape.

The second projection can be configured to be positioned on one side or only on one side of a respective second clamp fastener hole of the one or more second clamp fastener holes.

The respective second clamp fastener hole can define a second circumference and the second projection occupies or partially surrounds at least half, only half, or only less than half of the second circumference.

The one or more second clamp fastener holes can include a first hole and a second hole, and each of the first and the second holes can define a first axis and a second axis. The first axis can be oriented perpendicular to the second axis and intersects the second axis. The first projection can lie entirely on one side of the first axis of the first hole. The second projection can lie entirely on one side of the first axis of the second hole. The first projection can be symmetrical about the second axis of the first hole. The second projection can be symmetrical about the second axis of the second hole.

The second axis of the first hole and the second axis of the second hole can define a common second axis, and both the first and the second projections can be symmetrical about the common second axis. The first projection can be positioned on a first side of the first axis of the first hole. The second projection can be positioned on a same first side of the first axis of the second hole. The first projection and the second projection can define different visual shapes or different geometric shapes.

Increased or disproportionate friction between a first head surface of a first fastener and a corresponding first projection surface of a first projection can pull or walk or advance the edge-mount connector or a body toward and/or into physical, electrical, or both physical and electrical contact with the edge of the mating substrate.

As a second fastener is turned in the R direction or tightened, a second head surface of the second fastener head can physically engage a second corresponding projection.

Increased or disproportionate friction between the second head surface and a corresponding second projection surface of the second projection can pull, walk, or advance the edge-mount connector toward and/or into physical, electrical, or both physical and electrical contact with the edge of the mating substrate.

According to an embodiment of the present invention, a method of mounting an edge-mount connector to a substrate includes a step of providing an edge-mount connector and a step of positioning the edge-mount connector adjacent to a substrate edge of a substrate, the edge-mount connector including a body.

The method can further include a step moving a first end of the body of the edge-mount connector a greater distance toward the substrate edge of the substrate than an opposed second end of the body of the edge-mount connector. The method can further include a step of moving the second end of the body of the edge-mount connector a greater distance toward the substrate edge of the substrate than the opposed first end of the body of the edge-mount connector. The method can further include a step of moving the second end of the body of the edge-mount connector a greater distance toward the substrate edge of the substrate than the opposed first end of the body of the edge-mount connector after the step of moving the first end of the body of the edge-mount connector the greater distance toward the substrate edge of the substrate than the opposed second end of the body of the edge-mount connector.

According to an embodiment of the present invention, an edge-mount connector includes a body made from an electrically conductive material, a clamp that defines at least one indentation, and a fastener that is received by the clamp, the fastener including a fastener head that extends at least partially over, at least partially overhangs, or at least partially covers the indentation. The edge-mount connector can be a RF edge-mount connector.

According to an embodiment of the present invention, an edge-mount connector includes a body made from an electrically conductive material, a clamp that defines at least one projection, and a fastener that is received by the clamp, the fastener including a fastener head that extends at least partially over, at least partially overhang, or at least partially covers the projection. The edge-mount connector can be a RF edge-mount connector.

The above and other features, elements, characteristics, steps, and advantages of the present invention will become more apparent from the following detailed description of the embodiments of the present invention with reference to the attached drawings.

### BRIEF DESCRIPTION OF THE DRAWINGS

FIG. 1 is a perspective side view of an edge-mount connector according to a first embodiment of the present invention attached to an optional substrate or printed circuit board.

FIG. 2 is a top perspective end view of FIG. 1.

FIG. 3 is a bottom perspective side view of FIG. 1.

FIG. 4 is a bottom view of FIG. 1 with a first fastener removed for clarity.

FIG. 5 is a bottom perspective end view of FIG. 1 with the first faster and a second fastener removed for clarity.

FIG. 6 is a perspective side view of an edge-mount connector according to a second embodiment of the present invention with a first fastener removed for clarity.

FIG. 7 is perspective end view of FIG. 6.

FIG. 8 is a bottom perspective side view of FIG. 6 with first and second fasteners.

FIG. 9 is a bottom view of FIG. 6 with both first and second fasteners removed for clarity.

FIG. 10 is a bottom perspective view of FIG. 9.

FIGS. 11-13 show an example of a known edge-mount connector.

### DETAILED DESCRIPTION

The present invention relates to an edge-mount connector, such as an RF edge-mount connector, that pulls, pushes, walks, or advances toward a thickness edge or a substrate edge of a substrate as the edge-mount connector is mated with the thickness edge or the substrate edge of the substrate. A thickness edge or substrate edge can be defined as a thickness surface of the substrate that is perpendicular to a major surface of the substrate. The thickness edge or substrate edge of the substrate can be electrically conductive. The thickness edge or substrate edge can be electrically grounded. The edge-mount connector can be electrically conductive, such that at least a portion of the edge-mount connector or at least a portion of a body of the edge-mount connector electrically connects, physically connects, or both electrically and physically connects to the thickness edge or substrate edge. If the thickness edge or substrate edge is electrically grounded, then the edge-mount connector can also be grounded when the edge-mount connector is mated with the substrate or is mated with the thickness edge or substrate edge of the substrate.

Self-adjustment of the edge-mount connector with respect to an edge of a substrate can be provided by a direct or indirect interaction between a head of a rotatable fastener and a protrusion or projection or hole or any combination of a protrusion, projection, or hole defined by a portion of the edge-mount connector, for example, a clamp of the edge-mount connector or a body. The edge-mount connector or RF edge-mount connector can be devoid of lock washers or at least devoid of a lock washer between a head surface of a respective fastener and a respective clamp.

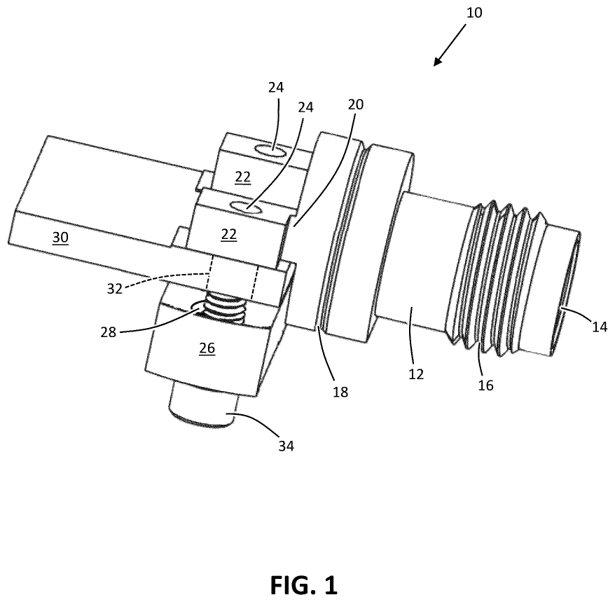

FIGS. 1-3 show an edge-mount connector 10 attached to an optional substrate or printed circuit board 30. The edge-mount connector 10 can be an RF edge-mount connector. As shown in FIG. 1, an edge-mount connector 10 according to a first embodiment of the present invention can define a port 12. The port 12 can define a cavity 14 and first external threads 16. The port 12 can be defined by a body 18. The body 18 can define one or more protrusions 20. Each respective one of the one or more protrusions 20 can individually or collectively engage with, be monolithically formed with, or be positioned adjacent to a first clamp 22. The first clamp 22 can be fixed with respect to port 12 or the body 18 and can define one or more respective first clamp fastener holes 24.

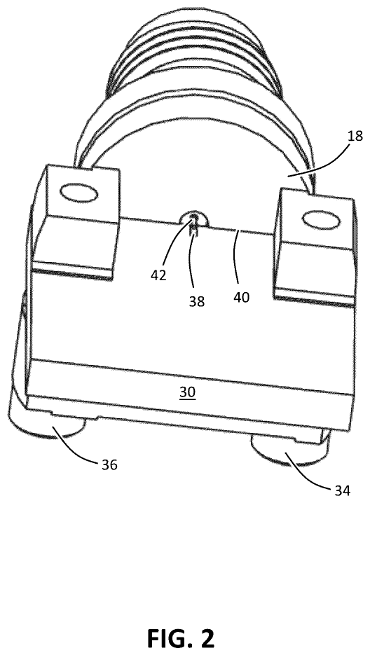

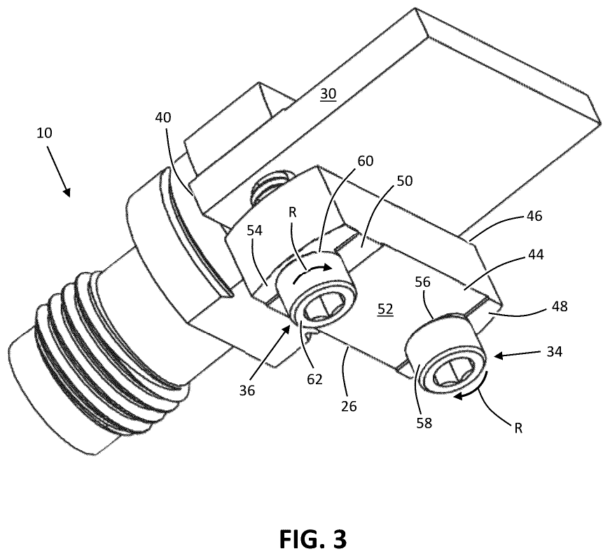

A second clamp 26 can move independently of the first clamp 22 and can define one or more second clamp fastener holes 28. Although not necessarily part of the edge-mount connector 10 itself, a substrate 30 can define one or more substrate fastener holes 32. The substrate 30 can be clamped between the first clamp 22 and the second clamp 26 when fasteners, such as first fastener 34 and/or second fastener 36 (shown in FIGS. 2 and 3), are rotated in a clockwise tightening direction or in a reverse thread counterclockwise tightening direction or, more generally, in any tightening direction.

As shown in FIG. 2, the substrate 30 can be a printed circuit board. The substrate 30 can define a substrate signal pad 38 and an electrically conductive thickness edge or substrate edge 40. The substrate signal pad 38 can be configured to receive a first signal conductor end 42 of the edge-mount connector 10. The edge-mount connector 10, or body 18 can be made from an electrically conductive material and can physically contact, electrically contact, or both physically and electrically contact the electrically conductive substrate edge 40 of the substrate 30.

As shown in FIG. 3, the second clamp 26 can define a first surface 44 of the second clamp 26 and an opposed second surface 46 of the second clamp 26. The first surface 44 can define a first projection 48, a second projection 50, or both the first projection 48 and the second projection 50. That is, the first surface 44 can define a first indentation 52, a second indentation 54, or both the first indentation 52 and the second indentation 54. The first projection 48 can be monolithic with or be defined by the second clamp 26. The second projection 50 can be monolithic with or be defined by the second clamp 26. The first indentation 52 can be monolithic with or be defined by the second clamp 26. The second indentation 54 can be monolithic with or be defined by the second clamp 26. Any one or more of the first projection 48, the second projection 50, the first indentation 52, and the second indentation 54 can be stationary, non-movable, and/or fixed with respect to the body 18 and/or the second clamp 26.

The first fastener 34 and the second fastener 36 can each be externally threaded and can each be individually rotated in a tightening direction, such as a clockwise direction R shown in FIG. 3. Once the edge-mount connector 10 is positioned on the substrate 30 and at least one fastener or at least two fasteners, such as the first fastener 34 and the second fastener 36, extend through the first clamp 22, the second clamp 26, and the substrate 30, the first fastener 34 and the second fastener 36 can each be alternatively rotated or tightened in the direction R. For example, the first fastener 34 can be rotated a quarter turn, a turn less than a full turn, a full turn, etc. The second fastener 36 can then be rotated a quarter turn, a turn less than a full turn, at least a full turn, etc. This rotation process can be repeated until the edge-mount connector 10 tightly abuts the substrate edge 40 and is in electrical contact, in physical contact, or in both electrical and physical contact with the substrate edge 40. Rotation is not limited to quarter turns or turns less than a full turn. Initial turns can be a full turn or more than a full turn.

As the first fastener 34 is turned in the R direction or otherwise tightened, a first head surface 56 of a first fastener head 58 can physically engage the first projection 48. Increased or disproportionate physical contact or friction between the first head surface 56 and a corresponding first projection surface of the first projection 48 can pull, urge, or walk a first end of the edge-mount connector 10 or the body 18 toward and/or into physical, electrical, or both physical and electrical contact with the substrate edge 40. The first end of the edge-mount connector 10 or the body 18 can be an end of the edge-mount connector 10 or the body 18 that is closer to the first fastener 34 than the second fastener 36. Accordingly, the increased or disproportionate physical contact or friction between the first head surface 56 and a corresponding first projection surface of the first projection 48 can move the first end of the edge-mount connector 10 or the body 18 a greater distance toward the substrate edge 40 than a second end of the edge-mount connector 10 or the body 18.

As the second fastener 36 is turned in the R direction or tightened, a second head surface 60 of a second fastener head 62 can physically engage the second projection 50. Increased or disproportionate physical contact or friction between the second head surface 60 and a corresponding second projection surface of the second projection 50 can pull, urge, or walk a second end of the edge-mount connector 10 or the body 18 toward and/or into physical, electrical, or both physical and electrical contact the substrate edge 40. The second end of the edge-mount connector 10 or the body 18 can be an end of the edge-mount connector 10 or the body 18 that is closer to the second fastener 36 than the first fastener 34. Accordingly, the increased or disproportionate physical contact or friction between the first head surface 56 and a corresponding first projection surface of the first projection 48 can move the second end of the edge-mount connector 10 or the body 18 a greater distance toward the substrate edge 40 than the first end of the edge-mount connector 10 or the body 18.

For example, the first and second fastener heads 58, 62 can respectively extend over both a respective projection 48, 50 and a respective indentation 52, 54, but only physically contact or frictionally engage, directly or indirectly, the respective projection 48, 50 or have more surface area of a respective first head surface 56 or second head surface 60 engage the respective projection 48, 50 versus a respective indentation 52, 54. This example can be defined as disproportionate physical or frictional contact.

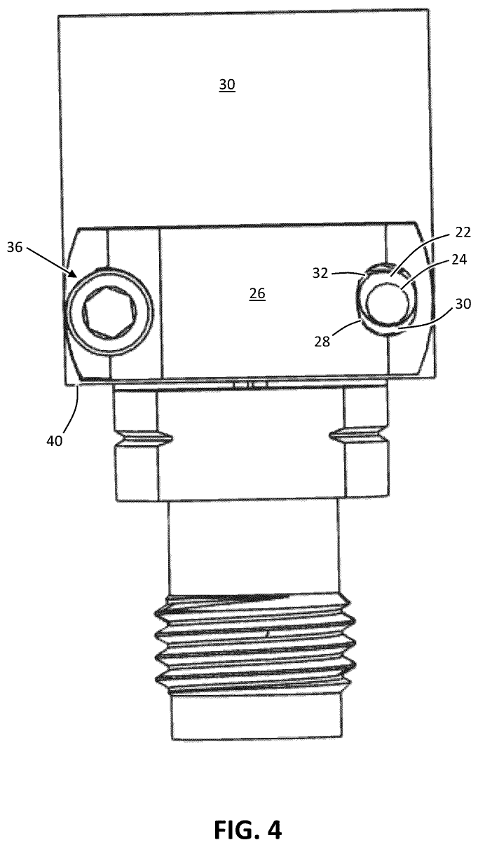

FIG. 4 is a bottom view of the of edge-mount connector 10 with the first fastener 34 removed for clarity. As shown in FIG. 4, a first clamp fastener hole 24 of the first clamp 22 can have an inner threaded diameter that is approximately equal to an outer threaded diameter of the first fastener 34, the second fastener 36, or both the first fastener 34 and the second fastener 36. For example, the first fastener 34 and/or the second fastener 36 can be each be threaded into a corresponding first clamp fastener hole 24 or second clamp fastener hole 28 and tightened. The second clamp fastener hole 28 and the substrate fastener hole 32 can both be oversized or have respective second and third inner diameters or circumferences that are each greater than the inner threaded diameter of the first clamp fastener hole 24. The oversized second clamp fastener hole 28 and the substrate fastener hole 32 can be configured to allow the first clamp 22 and the second clamp 26 to move closer to or away from the substrate 30, the substrate edge 40, or both the substrate 30 and the substrate edge 40. The second clamp 26 can move independently of the body 18, independently of the first clamp 22, or independently of both the body 18 and the first clamp 22.

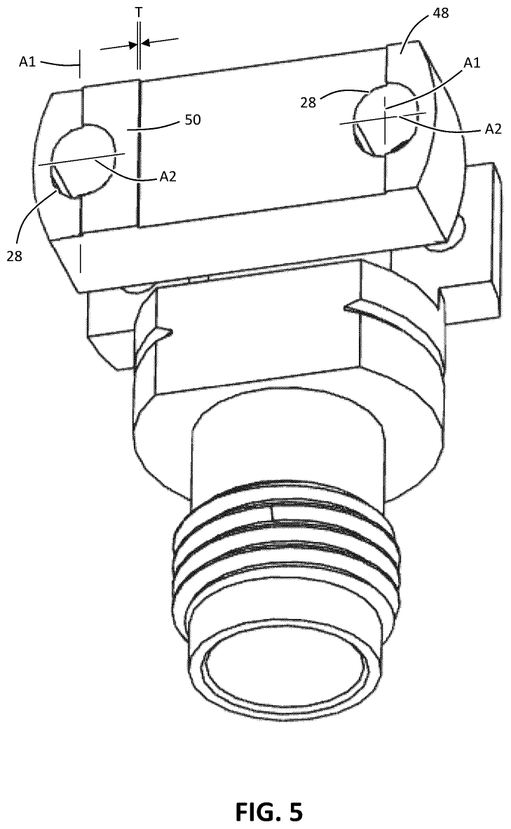

FIG. 5 is a bottom perspective end view of FIG. 1 with both the first fastener 34 and the second fastener 36 removed for clarity. FIG. 5 shows that the first projection 48, the second projection 50, or both the first projection 48 and the second projection 50 can have a thickness T. The thickness T can be approximately 0.1 mm to approximately 0.2 mm, approximately 0.5 mm to approximately 0.25 mm, or any other suitable thickness. The first projection 48 can be positioned on one side or only on one side of the respective second clamp fastener hole 28. Stated another way, the first projection 48 can define a C-shape. Stated yet another way, the respective second clamp fastener hole 28 can define a first circumference or first radius, and the first projection 48 can occupy or partially surround at least half, only half, or only less than half of the first circumference or first radius. The first projection 50 can be positioned on one side or only on one side of the respective second clamp fastener hole 28. Stated another way, the first projection 50 can define a C-shape. Stated yet another way, the respective second clamp fastener hole 28 can define a second circumference or second radius, and the first projection 50 can occupy or partially surround at least half, only half, or only less than half of the second circumference or second radius.

Each second clamp fastener hole 28 can define a first axis A1 and a second axis A2, as shown in FIG. 5. The first axis A1 can be oriented perpendicular to the second axis A2 and can intersect the second axis A2. The first projection 48 can lie entirely on one side of the first axis A1, can lie substantially on one side of the first axis A1, and/or can only lie on one side of the first axis A1. The second projection 50 can lie entirely on one side of the first axis A1, can lie substantially on one side of the first axis A1, and/or can only lie on one side of the first axis A1. The first projection 48 can be symmetrical about its respective second axis A2. The second projection 50 can be symmetrical about its respective second axis A2. The respective second axes A2 of the first and second projections 48, 50 can be a common second axis A2, and both the first and second projections 48, 50 can each be symmetrical about the common second axis A2. The first projection 48 can be positioned on a first side of its respective first axis A1 and the second projection 50 can be positioned on the same first side of its respective first axis A1. The first projection 48 and the second projection 50 can each define different visual shapes or different geometric shapes.

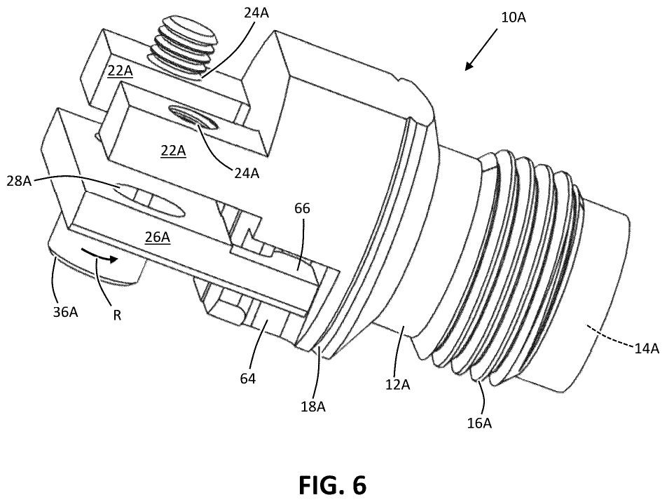

A second embodiment of an edge-mount connector 10A is shown in FIGS. 6-8. The edge-mount connector 10A can be an RF edge-mount connector. The edge-mount connector 10A can define a port 12A. The port 12A can define a cavity 14A and first external threads 16A. The port 12A can be defined by a body 18A. The body 18A can define one or more grooves 64. A first clamp 22A can define one or more respective first clamp fastener holes 24A.

A second clamp 26A can define one or more second clamp fastener holes 28A. Although not part of the edge-mount connector 10A itself, a substrate (e.g., substrate 30 as shown in FIG. 1 but not shown in FIGS. 6-10) can define one or more substrate fastener holes 32 (e.g., substrate fastener holes 32 as shown in FIG. 1 but not shown in FIGS. 6-10). The substrate can be clamped between the first clamp 22A and the second clamp 26A when fasteners, such as a first fastener 34A and/or second fastener 36A, are rotated in a clockwise, a reverse thread counterclockwise, or in a tightening direction R. Second clamp 26A can define one clamp guide 66, at least one clamp guide 66, two clamp guides 66, or at least two clamp guides 66. Each respective clamp guide 66 can be received in or engage a corresponding groove 64. Each groove 64 can define a respective channel and a respective clamp guide 66 can slide or move along a length of the respective channel.

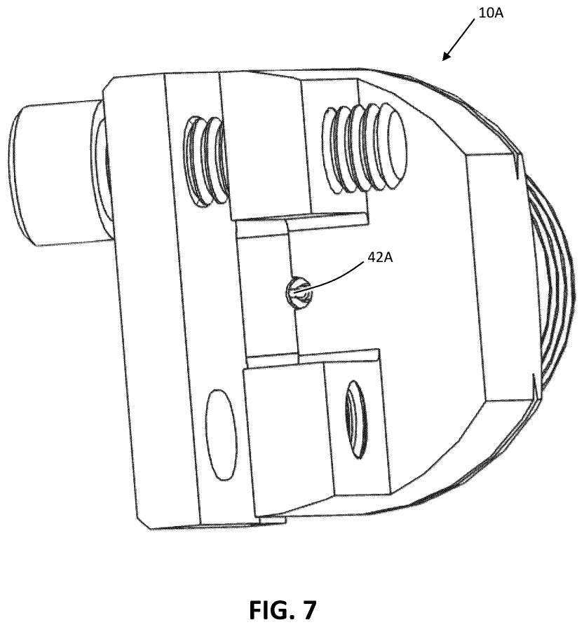

The substrate can be a printed circuit board, as described above with respect to FIG. 2. The substrate can define a substrate signal pad (e.g., substrate signal pad 38 as shown in FIG. 2 not shown in FIGS. 6-10) and an electrically conductive substrate edge (e.g., electrically conductive substrate edge 40 as shown in FIG. 2 but not shown in FIGS. 6-10). The substrate signal pad can be configured to receive, as shown in FIG. 7, a first signal conductor end 42A of the edge-mount connector 10A. The edge-mount connector 10A or body 18A can be made from an electrically conductive material and can physically contact, electrically contact, or both physically and electrically contact the electrically conductive substrate edge of the substrate.

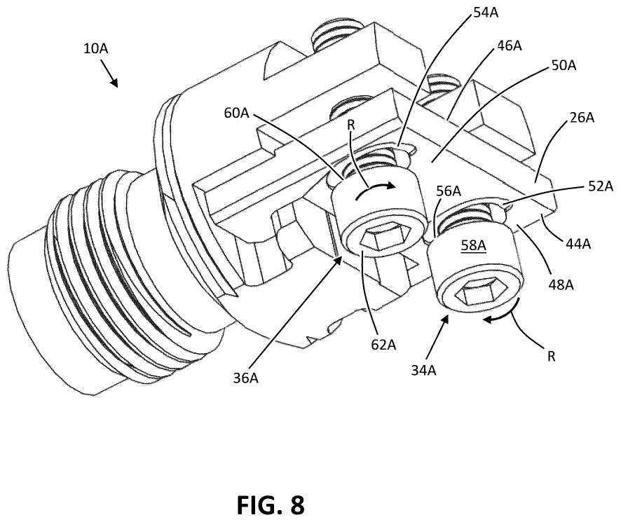

As shown in FIG. 8, the second clamp 26A can define a first surface 44A and an opposed second surface 46A. The first surface 44A can define a first projection 48A, a second projection 50A, or both the first projection 48A and the second projection 50A. That is, the first surface 44A can define a first indentation 52A, a second indentation 54A, or both the first indentation 52A and the second indentation 54A. The first projection 48A can be monolithic with the second clamp 26A and can be planar with the first surface 44A. The second projection 50A can be monolithic with the second clamp 26A and can be planar with the first surface 44A. The first indentation 52A can be monolithic with the second clamp 26A and the first surface 44A. The second indentation 54A can be monolithic with the second clamp 26 and the first surface 44A.

The first fastener 34A and the second fastener 36A can each be individually rotated in a direction R shown in FIG. 8, or in any other tightening direction. The first fastener 34A and the second fastener 36A can be alternatingly rotated or tightened in the direction R. For example, the first fastener 34A can be rotated a quarter turn, less than a full turn, a full turn, etc. The second fastener 36A can be rotated a quarter turn, less than a full turn, a full turn etc. This rotation process can be repeated, for example, until the edge-mount connector 10A tightly abuts the substrate edge 40 and is in electrical contact, in physical contact, or in both electrical and physical contact with the substrate edge 40. Rotation is not limited to quarter turns or turns less than a full turn.

As the first fastener 34A is turned in the R direction or otherwise tightened, a first head surface 56A of a first fastener head 58A can physically engage the first projection 48A. Increased or disproportionate friction between the first head surface 56A and a corresponding first projection surface of the first projection 48A can pull the edge-mount connector 10A or the body 18A toward and/or into physical, electrical, or both physical and electrical contact with the substrate edge (for example, as shown in FIG. 3 with respect to the edge-mount connector 10). As the second fastener 36A is turned in the R direction or otherwise tightened, a second head surface 60A of a second fastener head 62A can physically engage the second projection 50A. Increased or disproportionate friction between the second head surface 60A and a corresponding second projection surface of the second projection 50A can pull the edge-mount connector such as edge-mount connector 10A or the body 18A toward and/or into physical, electrical, or both physical and electrical contact the substrate edge (for example, as shown in FIG. 3 with respect to the edge-mount connector 10). For example, the first and second fastener heads 58A, 62A can respectively extend over both a respective projection 48A, 50A and a respective indentation 52A, 54A, but only physically contact or frictionally engage, directly or indirectly, a respective projection 48A, 50A or have more surface area of a respective first head surface 56A or a respective second head surface 60A engage more of the respective projection 48A, 50A versus the respective indentation 52A, 54A. This example can be defined as disproportionate physical or frictional contact.

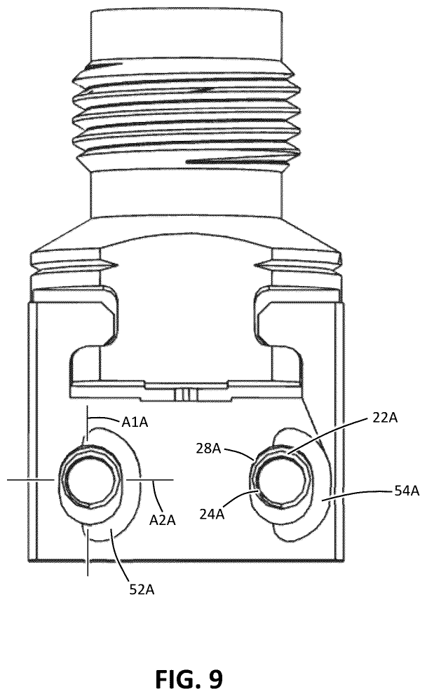

FIG. 9 is a bottom view of the edge-mount connector 10A with both first and second fasteners 34A, 36A removed for clarity. As shown in FIG. 9, a first clamp fastener hole 24A of the first clamp 22A can have an inner threaded diameter that is approximately equal to an outer threaded diameter of the first fastener 34A (shown in FIG. 8), the second fastener 36A (shown in FIG. 8), or both the first fastener 34A and the second fastener 36A. For example, the first fastener 34 and/or the second fastener 36 can be each be threaded into a corresponding first clamp fastener hole 24A and tightened. The second clamp fastener hole 28A and the substrate fastener hole (e.g., substrate fastener hole 32 as shown in FIG. 4 but now shown in FIGS. 6-10) can both be oversized or have second and third inner diameters that are each greater than the inner threaded diameter of the first clamp fastener hole 24A. The oversized second clamp fastener hole 28A and the substrate fastener hole (as shown in FIG. 4) can be configured to allow the first clamp 22A and the second clamp 26A to move with respect to the substrate (as shown in FIG. 3), the substrate edge (as shown in FIG. 3), or both the substrate and the substrate edge.

Each second clamp fastener hole 28A can define a first axis A1A and a second axis A2A. The first axis A1A can be oriented perpendicular to the second axis A2A and can intersect the second axis A2A. A respective first indentation 52A can lie entirely on one side of a respective first axis A1A, can lie substantially on one side of a respective first axis A1A, and/or can only lie on one side of a respective first axis A1A. A respective second indentation 54A can lie entirely on one side of a respective first axis A1A, can lie substantially on one side of a respective first axis A1A, and/or can only lie on one side of a respective first axis A1A. One or both of the respective first and second indentions 52A, 54A can each extend beyond the first axis A1A. The first indentation 52A can be symmetrical about its respective second axis A2A. The second indentation 54A can be symmetrical about its respective second axis A2A. The respective second axes A2A of the first and second indentations 52A, 54A can be a common second axis A2A, and both the first and second indentation 52A, 54A can each be symmetrical about the common second axis A2A. A respective first indentation 52A can be positioned on a first side of its respective first axis A1A and a respective second indentation 54A can be positioned on the same first side of its respective first axis A1A. The first indentation 52A and the second indentation 54A can each define different visual or different geometric shapes.

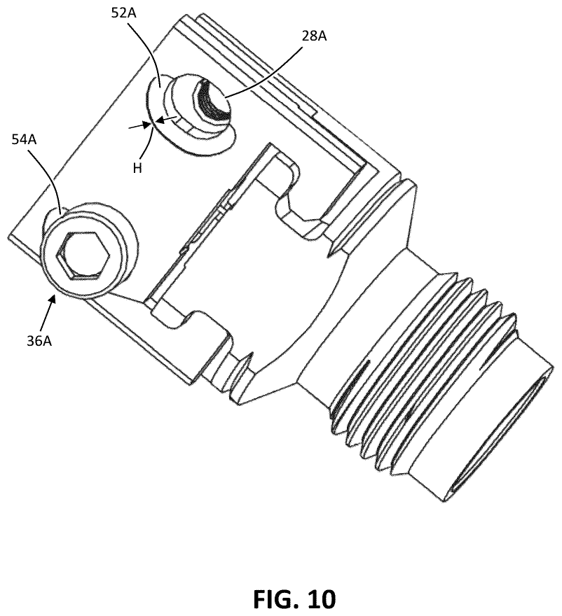

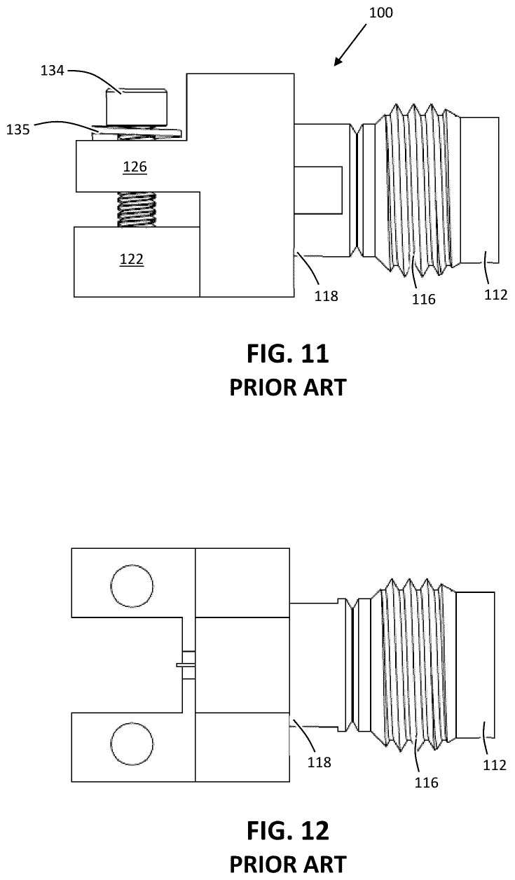

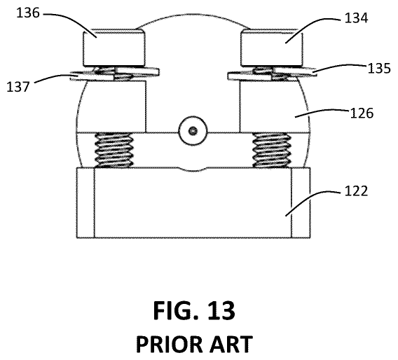

FIG. 10 is another bottom view of the edge-mount connector 10A with the first fastener 34A removed for clarity. FIG. 10 shows that the first indentation 52A, the second indentation 54A, or both the first indentation 52A and the second indentation 54A can have a respective height H. The height H can be approximately 0.1 mm to approximately 0.2 mm. The first indentation 52A can be positioned on one side or only on one side of the respective second clamp fastener hole 28A. The first indentation 52A can define a C-shape. Stated yet another way, the respective second clamp fastener hole 28A can define a first circumference and the first indentation 52A can occupy or partially surround at least half, only half, only less than half, more than half but less than three-quarters, or at least three quarters of the first circumference length of the second clamp fastener hole 28A. The second indentation 54A can be positioned on one side or only on one side of the respective second clamp fastener hole 28A. Stated another way, the second indentation 54A can define a C-shape. Stated yet another way, the respective second clamp fastener hole 28A can define a second circumference and the second indentation can occupy or partially surround at least half, only half, or only less than half of the second circumference of the second clamp fastener hole 28A.

An edge-mount connector 10, 10A can include a body 18, 18A made from an electrically conductive material, a second clamp 26, 26A that can define at least one first indentation 52, 52A, at least one first projection 46, 46A or both, and a first fastener 34, 34A that can be configured to be received by the second clamp 26, 26A. The first fastener 34, 34A can have a first fastener head 58, 58A that extends at least partially over or at least partially overhangs or at least partially covers the first indentation 52, 52A, the first projection 46, 46A, or both the first indentation 52, 52A and the first projection 46, 46A.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Monolithic can mean a single, uniform whole or a single, rigid, uniform whole.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. For example, the first clamp 22, 22A can have first clamp fastener holes 24, 24A that are unthreaded, with the second clamp fastener holes 28, 28A being threaded. The first projection 48, 48A, the second projection 50, 50A, first indentation 52, 52A, and second indentation 54, 54A can be positioned on, be defined by, or be positioned adjacent to the first clamp 22, 22A. The present invention is not limited to RF edge-mount connectors and can be used with any type of suitable edge-mount connector. The described embodiments were chosen and described in order to best explain the principles of the disclosure and the practical application, and to enable others of ordinary skill in the art to understand the disclosure for various embodiments with various modifications as are suited to the particular use contemplated.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1-55. (canceled)

56. An RF edge-mount connector comprising:
a first clamp defining a first fastener hole;
a second clamp defining a second fastener hole and defining a first projection or a first indentation;
a connector body physically connected to the first clamp; and
a first fastener including a head portion and a shaft portion, wherein the shaft portion of the first fastener is structured to pass through the first fastener hole and the second fastener hole,
the second fastener hole is oversized with respect to a diameter of the shaft portion of the first fastener, and
the RF edge-mount connector is configured to walk or advance toward an edge of a mating substrate, when the RF edge-mount connector is mated with the mating substrate, through a direct or indirect interaction between the head portion of the first fastener and the first projection or the first indentation of the second clamp.

57. The RF edge-mount connector of claim 56, wherein the second fastener hole is configured to allow the second clamp to move with respect to the connector body.

58. The RF edge-mount connector of claim 56, wherein the connector body defines one or more protrusions.

59. The RF edge-mount connector of claim 58, wherein the one or more protrusions individually or collectively engage with, are monolithically formed with, or are positioned adjacent to the first clamp.

60. The RF edge-mount connector of claim 56, wherein the first fastener is configured to be threaded into the first fastener hole and tightened.

61. The RF edge-mount connector of claim 56, wherein the first fastener hole has a diameter equal or substantially equal to the diameter of the shaft portion of the first fastener.

62. The RF edge-mount connector of claim 56, wherein the first fastener is a rotatable fastener.

63. The RF edge-mount connector of claim 56, wherein:
the first fastener is arranged to pass through a through-hole provided in the mating substrate, and
the through-hole provided in the mating substrate is oversized with respect to the diameter of the shaft portion of the first fastener.

64. The RF edge-mount connector of claim 56, further comprising:
a second fastener including a head portion and a shaft portion, wherein
the first clamp defines a third fastener hole,
the second clamp defines a second fastener hole, and
the shaft portion of the second fastener is structured to pass through the third fastener hole and the fourth fastener hole.

65. The RF edge-mount connector of claim 64, wherein:
the second clamp further defines a second projection or a second indentation, and
the RF edge-mount connector is further configured to walk or advance toward an edge of a mating substrate, as the RF edge-mount connector is mated with the mating substrate, through a direct or indirect interaction between the head portion of the second fastener and the second projection or the second indentation of the second clamp.

66. An RF edge-mount connector comprising:
a body;
a first clamp fixed to the body and including first and second fastener holes;
a second clamp movable with respect to the body and including third and fourth fastener holes;
a first rotatable fastener extending through the first and the third fastener holes; and
a second rotatable fastener extending through the second and the fourth fastener holes; wherein
the third fastener hole is oversized with respect to the first rotatable fastener and the fourth fastener hole is oversized with respect to the second rotatable fastener such that the RF edge-mount connector is configured to walk or advance toward an edge of a mating substrate, when the RF edge-mount connector is mated with the mating substrate, by alternatively tightening the first and the second rotatable fasteners.

67. The RF edge-mount connector of claim 66, wherein the third and fourth fastener holes are configured to allow the second clamp to move with respect to the body.

68. The RF edge-mount connector of claim 66, wherein the third and fourth fastener holes are unthreaded.

69. The RF edge-mount connector of claim 66, wherein the first and the second rotatable fasteners are each individually rotatable in a corresponding tightening direction.

70. A connector system comprising:
the RF edge-mount connector of claim 66; and
the mating substrate.

71. The connector system of claim 70, wherein
the mating substrate is between the first and the second clamps and includes first and second substrate fastener holes;
the first rotatable fastener extends through the first substrate fastener hole; and
the second rotatable fastener extends through the second substrate fastener hole.

72. The connector system of claim 70, wherein
the first substrate fastener hole is oversized with respect to the first rotatable fastener; and
the second substrate fastener hole is oversized with respect to the second rotatable fastener.

73. The connector system of claim 70, when the RF edge-mount connector is mated with the mating substrate, the body of the edge-mount connector is in physical contact with an edge of the mating substrate

74. The connector system of claim 70, wherein an edge of the mating substrate includes an electrically conductive portion.

75. The connector system of claim 74, wherein:
the body of the RF edge-mount connector includes an electrically conductive material, and
when the RF edge-mount connector is mated with the mating substrate, the body of the RF edge-mount connector physically contacts, electrically contacts, or both physically and electrically contacts the electrically conductive portion of the edge of the mating substrate.
